(19) United States
(12) Patent Application Publication
(10) Pub. No.: US 2022/0253505 A1
(43) Pub. Date: Aug. 11, 2022

(54) FEEDBACK APPARATUS AND FFT/IFFT PROCESSOR

(71) Applicant: SHENZHEN POLYTECHNIC, Shenzhen, Guangdong (CN)

(72) Inventors: Jianbiao HE, Shenzhen, Guangdong (CN); Xiaoming MA, Shenzhen, Guangdong (CN)

(21) Appl. No.: 17/630,023

(22) PCT Filed: Jul. 9, 2020
(86) PCT No.: PCT/CN2020/101071

§ 371 Date: Jan. 25, 2022

(30) Foreign Application Priority Data
Mar. 24, 2020 (CN) 202010211969.9

(51) Int. Cl. G06F 17/14; G06F 7/523; G06F 7/501

(52) U.S. Cl. CPC G06F 17/142; G06F 7/5016; G06F 7/523

(57) ABSTRACT

A feedback apparatus and an FFT/IFFT processor. The apparatus comprises a radix-4 cascading operation module; radix-4 cascading operation module comprises: a twiddle factor generating unit, a complex multiplier, a delay switching unit, a butterfly operation unit, and an output switching unit; delay switching unit connects to the butterfly operation unit, complex multiplier, and output switching unit, respectively; and output switching unit connects to butterfly operation unit and delay switching unit. In present invention, on basis of the complex multiplier being fully utilized, and by using a dual-delay feedback structure circuit and designing a data delay buffer channel, the use efficiency of complex adders/subtractors is more effectively improved, the number of complex adders/subtractors required is evidently reduced, and circuit efficiency is significantly improved, thus effectively solving the problem in which radix-4SDF and radix-4SDC structures occupy a relatively large number of complex adders/subtractors.

### CROSS-REFERENCES TO RELATED APPLICATIONS

This application is a national application of PCT Patent Application No. PCT/CN 2020/101071, filed on Jul. 9, 2021, which claims priority to Chinese Patent Application No. 202010211969.9, filed on Mar. 24, 2020. The content of all of which is incorporate herein by reference.

### FIELD OF THE INVENTION

The present application relates to the technical field of electronic communication, in particular to a feedback apparatus and an FFT/IFFT processor.

### BACKGROUND

Fast Discrete Fourier Transform (FFT)/Inverse Fast Fourier Transform (IFFT) is a quick implementation of Discrete Fourier Transform (DFT)/Inverse Discrete Fourier Transform (IDFT), which is a commonly used technology in digital signal processing.

Due to a calculation process defined by the DFT and that by the IDFT are very similar, both FFT and IFFT may adopt a same circuit structure and a same implementation method.

Cooley and Tukey invented an algorithm of the FFT, a basic idea of the FFT is a DFT decomposing an original N-point sequence into two or more short sequences before being recombined into the original sequence, making a number of a plurality of calculations in an indirect algorithm much less than that when directly calculating the DFT, thereby improving a calculation speed of the DFT.

An FFT/IFFT decomposition calculation, according to a number of the short sequences of the decomposition, may divide the FFT/IFFT algorithm into a plurality of types, which are generally referred to as a radix-S algorithm.

For example, a radix-2 FFT algorithm may decompose an N-point DFT operation into 2-point DFT calculation processes having a number of

$$\frac{N}{2} {log}_{2} N ;$$

a radix-4 FFT algorithm may decompose the N-point DFT operation into 4-point DFT calculation processes having a number of

$$\frac{N}{2} {log}_{4} N ;$$

a radix-8 FFT algorithm may decompose the N-point DFT operation into 8-point DFT calculation processes having a number of

$$\frac{N}{8} {log}_{8} N .$$

Theoretically, the larger the radix-S of the decomposition calculation is, the higher an efficiency of a decomposition algorithm is, however, in fact, since a DFT operation module with 8 points and above requires a complex multiplier, and the larger the S is, the more the complex multipliers of the DFT operation module accordingly are. Thus a number of the complex multipliers actually required by a DFT decomposition algorithms with 8 points and above is not little, which are rarely applied in an engineering. An FFT/IFFT processor currently used is generally adopting a radix-2 or radix-4 decomposition algorithm.

A hardware implementation structure of a current FFT processor comprises a recursive structure, a pipeline structure and a fully parallel structure

The recursive structure is also called a memory-share structure, occupying a least hardware resource and having only one arithmetic processing unit. However, a long operation time is required, without being able to process an FFT calculation request continuously, while only being suitable for an occasion where an FFT calculation is occasionally required. The pipeline structure adopts a multi-level calculation unit, wherein a next FFT may be calculated after a previous operation unit sends a result to a next operation unit, without having to wait for the FFT calculation to be finished. The pipeline structure is able to calculate an N-point FFT without an overlap between a previous data and a next data continuously. While for a continuous FFT calculation having a previous data and a next data overlapping, only a fully parallel structure may be adopted. Each level of calculation of such a structure sets an operation unit correspondingly for the number of N-points, while each level of a calculation delay may be as low as a single system clock cycle, being able to achieve a continuous calculation for any N-point FFT, however taking up a huge hardware resource.

In a real application, there are very few occasions where a continuous calculation for any N-point FFT is required, thus an FFT processor adopting a pipeline design is the most common.

The pipeline structure of the FFT processor stated above has mainly 3 types: a single-path delay commutator (SDC), a multi-path delay commutator (MDC) and a single-path delay feedback (SDF).

Accordingly, the pipeline structure of the FFT processor adopting the radix-2 algorithm comprises three structures of R2SDC, R2SDF, R2MDC and more; the pipeline structure of the FFT processor adopting the radix-4 algorithm comprises three structures of R4SDC, R4SDF, R4MDC and more.

Since a R2SDC structure has no advantage over the R2SDF in a radix 2 butterfly decomposition calculation, thus a radix-2 FFT processor mainly adopts a R2MDC structure and a R2SDF structure. Both the R2MDC structure and the R2SDF structure have a characteristic of a simple control and an easy implementation, occupying a circuit resource having no much difference, wherein, the R2SDF structure requires a little less memory, while the R2MDC structure has a shorter calculation delay.

However, a common shortcoming of both the R2MDC and the R2SDF structures is that a utilization rate of the complex multiplier is relatively low (50% only), thus an entire FFT processor requires a large number of the complex multipliers.

Since an FFT/IFFT calculation is composed of a complex multiplication calculation and a complex addition/subtraction calculation, while the multiplication calculation is far more complicated than the addition/subtraction calculation, thus a circuit scale of the FFT processor is mainly determined by the complex multiplier. And a main defect of the R2MDC structure and the R2SDF structure is that a low utilization rate of the complex multiplier leads to a large occupation of the circuit resources.

The R4MDC structure is the simplest among three pipeline implementation structures of a radix-4 decomposition algorithm, having a shortcoming very significant, that is, a 4-way delay adapter structure requires a complex multiplier, a butterfly operator BF and a storage unit independently. A utilization rate of these hardware circuit units is low (25% only), thus a number of various hardware circuit units required by an FFT processor adopting the R4MDC structure is more than that of the FFT processor adopting the R2MDC structure and the R2SDF structure, which is a low-efficiency single-channel FFT processor implementation structure.

The R4SDF structure is a relatively high-efficiency FFT processor implementation structure, since a serial data stream is able to fully use the complex multiplier, that makes a utilization efficiency of the complex multiplier reach 75%, while the complex multipliers required by the entire FFT processor are half of the R2MDC structure and the R2SDF structure; a storage capacity required by the R4SDF structure is equivalent to that of the R2SDF, which is one-third less than that of the R2MDC structure; however, a biggest drawback of the R4SDF is that a number of a plurality of complex adders required is relatively large, twice of a number of the complex adders required by the R2SDF.

Comparing with a plurality of shortcomings of the R4SDF structure, the R4SDC structure may effectively reduce the complex adders (62.5%), while a number of the complex multipliers required is also as same as that of the R4SDF structure. However, the storage capacity required by the R4SDC structure is increased (100%) compared to that of the R4SDF structure, and a control logic circuit of the R4SDC structure is very complicated, relatively hard to achieve.

Therefore, the current technology needs to be improved and developed.

### BRIEF SUMMARY OF THE DISCLOSURE

According to the defects in the prior art described above, the present application provides a feedback apparatus and an FFT/IFFT processor, applied to solving a technical problem in the prior art that, the R4SDF structure and the R4SDC structure in an existing FFT/IFFT processor occupy relatively more complex adders/subtractors.

The technical solution of the present application to solve the technical problems is as follows:

A feedback apparatus, wherein the apparatus comprises a radix-4 cascading operation module; the radix-4 cascading operation module comprises: a twiddle factor generating unit, a complex multiplier, a delay switching unit, a butterfly operation unit, and an output switching unit; the complex multiplier connects to the twiddle factor generating unit and the delay switching unit respectively, the delay switching unit connects to the butterfly operation unit, the complex multiplier and the output switching unit respectively, the output switching unit connects to the butterfly operation unit and the delay switching unit;

the twiddle factor generating unit is applied to generating a plurality of twiddle factors required by the radix-4 cascading operation module;

the complex multiplier is applied to calculating a product of a serial input data and a corresponding twiddle factor, before transmitting an output data calculated to the delay switching unit;

the delay switching unit is applied to delaying the output data calculated by the complex multiplier and a feedback data output by the output switching unit for a preset time and adjusting an order of the output data, before transmitting to the butterfly operation unit and the output switching unit respectively;

the butterfly operation unit is applied to performing a butterfly operation on the output data from the delay switching unit, and transmitting a plurality of calculation results to the output switching unit;

the output switching unit selects a data from the calculation results of the butterfly operation unit and the data transmitted by the delay switching unit, before outputting and feeding back to the delay switching unit.

Further, the feedback apparatus, wherein the delay switching unit comprises a first data selector, a second data selector, a third data selector, a first data delayer, a second data delayer, and a third data delayer;

the first data selector connects respectively to the complex multiplier, the output switching unit, the first data delayer and the second data delayer;

the second data selector connects respectively to the complex multiplier, the third data delayer and the butterfly operation unit;

the third data selector connects respectively to the second data delayer, the output switching unit and the third data delayer;

the first data delayer connects respectively to the first data selector and the butterfly operation unit;

the second data delayer connects respectively to the output switching unit, the first data selector and the third data selector;

the third data delayer connects respectively to the second data selector, the third data selector and the output switching unit;

the first data selector is applied to selecting a data from the output data of the complex multiplier, the output switching unit or the second data delayer, before transmitting to the first data delayer;

the second data selector is applied to selecting a data from the output data of the complex multiplier or the third data delayer, before outputting to the butterfly operation unit;

the third data selector is applied to selecting a data from the output data of the second data delayer or the output switching unit, before transmitting to the third data delayer;

the first data delayer is applied to delaying the data selected by the first data selector for a first valid clock period before transmitting to the butterfly operation unit;

the second data delayer is applied to delaying the output data from the output switching unit for a second valid clock period before transmitting to the first data selector and the third data selector;

the third data delayer is applied to delaying the data selected by the third data selector for a third valid clock period before transmitting to the second data selector and the output switching unit.

Further, the feedback apparatus, wherein the delay switching unit further comprises a delay switching state controller;

the delay switching state controller is applied to controlling the first data selector, the second data selector, and the third data selector to select an input data correspondingly at a different time point according to a preset switching control instruction.

Further, the feedback apparatus, wherein the butterfly operation unit comprises a complex adder and a complex subtractor;

the complex adder is applied to performing a time-sharing addition operation on the input data respectively before transmitting to the output switching unit;

the complex subtractor is applied to performing a time-sharing subtraction on the input data respectively before transmitting to the output switching unit;

the complex adder connects to the delay switching unit and the output switching unit;

the complex subtractor connects to the delay switching unit and the output switching unit.

Further, the feedback apparatus, wherein the output switching unit comprises a fourth data selector, a fifth data selector, and a constant multiplier;

the fourth data selector connects respectively to the butterfly operation unit and the delay switching unit;

the fifth data selector connects respectively to the butterfly operation unit, the constant multiplier and the delay switching unit;

the constant multiplier connects respectively to the butterfly operation unit and the fifth data selector;

the fourth data selector is applied to selecting a data from the output data of the butterfly operation unit or the delay switching unit as a calculation result for output;

the fifth data selector is applied to selecting a data from the output data of the butterfly operation unit or the constant multiplier before feeding back to the delay switching unit;

the constant multiplier is applied to performing a rotation and complement operation on a real part and an imaginary part of the input data, before transmitting an operation result to the fifth data selector.

Further, the feedback apparatus, wherein the output switching unit further comprises an output switching state controller;

the output switching state controller is applied to controlling the fourth data selector and the fifth data selector to select an input data at a different time point correspondingly according to a preset switching control instruction.

An FFT/IFFT processor, wherein comprising a plurality of radix-4 cascading operation modules in a number of L in a feedback apparatus;

a calculation method of the radix-4 cascading operation modules in the number of L is as follows:

L=┌log₄ N┐, wherein decomposing an FFT calculation into L levels of radix-4 decomposition operation, each radix-4 cascading operation module is responsible for one level of the radix-4 decomposition operation thereof, there are radix-4 cascading operation modules in a number of L, and N is a length of the FFT calculation, ┌⋅┐ is a round-up function.

Further, the FFT/IFFT processor, wherein for an i-th radix-4 cascading operation module, a data cycle period M is calculated as follows:

M=4N*4⁻ⁱ, wherein M is the data cycle period of a certain radix-4 cascading operation module, N is a length of the FFT calculation, i∈[1, L].

Further, the FFT/IFFT processor, wherein each radix-4 cascading operation module in the radix-4 cascading operation modules in the number of L adopts a single-path data transmission in between.

Benefits: the present application provides a feedback apparatus and an FFT/IFFT processor, the apparatus comprises a radix-4 cascading operation module; the radix-4 cascading operation module comprises: a twiddle factor generating unit, a complex multiplier, a delay switching unit, a butterfly operation unit, and an output switching unit; the complex multiplier connects to the twiddle factor generating unit and the delay switching unit respectively, the delay switching unit connects to the butterfly operation unit, the complex multiplier and the output switching unit respectively, the output switching unit connects to the butterfly operation unit and the delay switching unit. On a basis of making a full use of the complex multiplier, the present invention improves effectively a use efficiency of the complex adder/subtractor by using a double-delay feedback structure circuit and designing a data delay buffer channel ingeniously, reducing a number of the complex adders required significantly, and improving a circuit efficiency significantly; which has solved effectively a problem of the R4SDF structure and the R4SDC structure occupying more complex adders/subtractors.

### BRIEF DESCRIPTION OF THE DRAWINGS

FIG. 1 illustrates a schematic diagram on an external port of a radix-4 cascading operation module in a feedback apparatus of the present application;

FIG. 2 illustrates a schematic diagram on an internal structure of the radix-4 cascading operation module in the feedback apparatus of the present application;

FIG. 3 illustrates a schematic diagram on an external port of a butterfly operation unit in the radix-4 cascading operation module in the feedback apparatus of the present application;

FIG. 4 illustrates a schematic diagram on an external port of a delay switching unit in the radix-4 cascading operation module in the feedback apparatus of the present application;

FIG. 5 illustrates a schematic diagram on an internal structure of the delay switching unit in the radix-4 cascading operation module in the feedback apparatus of the present application;

FIG. 6 illustrates a schematic diagram on a work process of the delay switching unit in the radix-4 cascading operation module in the feedback apparatus of the present application;

FIG. 7 illustrates a schematic diagram on an external port of the output switching unit in the radix-4 cascading operation module in the feedback apparatus of the present application;

FIG. 8 illustrates a schematic diagram on an internal structure of the output switching unit in the radix-4 cascading operation module in the feedback apparatus of the present application;

FIG. 9 illustrates a schematic diagram on a work process of the output switching unit in the radix-4 cascading operation module in the feedback apparatus of the present application;

FIG. 10 illustrates a schematic diagram on an external port of an FFT/IFFT processor in the present application;

FIG. 11 illustrates a schematic diagram on a connection between each level of the radix-4 cascading operation modules in the FFT/IFFT processor of the present application;

### DETAILED DESCRIPTION OF EMBODIMENTS

In order to make the purpose, technical solution and the advantages of the present application clearer and more explicit, further detailed descriptions of the present application are stated herein, referencing to the attached drawings and some embodiments of the present application. It should be understood that the detailed embodiments of the application described here are used to explain the present application only, instead of limiting the present application.

In view of a plurality of defects in a R4MDC structure, a R4SDF structure and a R4SDC structure in a common pipeline structure, the present application discloses a feedback apparatus, proposing creatively a radix-4 single path-double delay feedback (R4SP-DDF) structure, on a basis of making a full use of a complex multiplier (a utilization rate 75%, having a same structure of the R4SDF and the R4SDC), by using a double-delay feedback structure circuit and designing a data delay buffer channel ingeniously, improving a usage efficiency of a BF2 (a complex adder), solving effectively a problem of the R4SDF structure and the R4SDC structure occupying more complex adders/subtractors. Comparing to the R4SDF structure, an amount of the complex adder is reduced (75%), comparing to the R4SDC structure, an amount of the complex adder is also reduced (33%).

In view of a fact that several FFT/IFFT processor implementation structures (R4SDF/R4SDC/R4MDC) of above-mentioned radix-4 decomposition algorithm all have a defect of a utilization efficiency low of the complex adders, the present application further decomposes the radix-4 decomposition algorithm of an FFT calculation, let:

$$\{ \begin{matrix}E = A + {W}_{N}^{2 k} C \\ F = A - {W}_{N}^{2 k} C \\ G = {W}_{N}^{k} B + {W}_{N}^{3 k} D \\ H = {W}_{N}^{k} B - {W}_{N}^{3 k} D , J = ( - j ) \times H\end{matrix}$$

then an output sequence X(k) of the FFT/IFFT processor may be further decomposed and expressed as:

$$\{ \begin{matrix}X ( k ) = E + G \\ X ( k + \frac{2 N}{4} ) = E - G \\ X ( k + \frac{N}{4} ) = F + J \\ X ( k + \frac{3 N}{4} ) = F - J .\end{matrix}$$

According to a decomposition process stated above, a radix-4 decomposition calculation achieved by the radix-4 cascading operation module, may roughly be decomposed into 4 addition operations (A+W_{N}^{2k}C, W_{N}^{k}B+W_{N}^{3k}D, E+G, F+J) and 4 subtraction operations (A−W_{N}^{2k}C, W_{N}^{k}B−W_{N}^{3k}D, E−G, F−J) to achieve. That is, the radix-4 decomposition calculation achieved by the radix-4 cascading operation module may be decomposed into 4 addition operations, 4 subtraction operations and 1 (−j) multiplication operation. Since a real part and an imaginary part of a circuit of the FFT/IFFT processor are calculated separately, a complex multiplier for a pure imaginary needs only to perform a simple data exchange and a complement processing; while the 4 addition operations and the 4 subtraction operations can be achieved one by one through a time-sharing calculation by the complex adder/subtractor, thus the utilization efficiency of the complex adder/subtractor can be effectively improved (upto 100%).

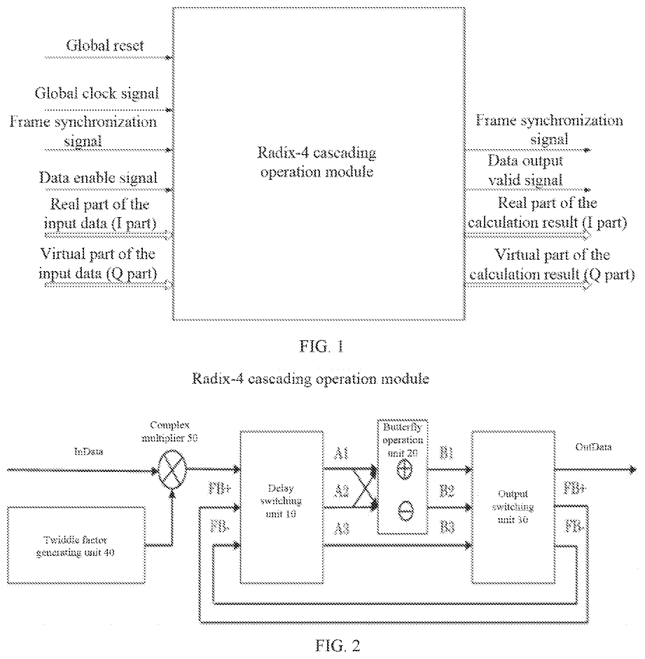

Referencing to FIG. 1, which illustrates a schematic diagram on an external port of a radix-4 cascading operation module in a feedback apparatus of the present application;

The external port of the radix-4 cascading operation module provided by the embodiment of the present invention comprises an input port and an output port, wherein the input port comprises:

Reset, Clock, In_DataSync, In_DataEna, In_DataI and In_DataQ, wherein the Reset and the Clock are a global reset and a global clock signal; the In_DataI and the In_DataQ are serial input data, the In_DataI is a real part of the input data (I part) and the In_DataQ is a virtual part of the input data (Q part); the In_DataEna is a data enable signal, and only when the In_DataEna is valid, will the In_DataI and the In_DataQ input are valid; the In_DataSync is a frame synchronization signal, the In_DataSync is valid only when a first data of a data frame is input, and the In_DataSync is invalid at other time.

The output port comprises:

Out_DataSync, Out_DataValid, Out_DataI and Out_DataQ, wherein the Out_DataI and the Out_DataQ are serial output data, the Out_DataI is a real part (I part) of the calculation result and the Out_DataQ is a virtual part (Q part) of the calculation result; the Out_DataValid is a data output valid signal, and only when the Out_DataValid is valid, will the Out_DataI and the Out_DataQ in an output result are valid; the Out_DataSync is a frame synchronization signal, the Out_DataSync is valid only when a first data of a data frame is output, and the Out_DataSync outputs an invalid level at all other time.

Referencing to FIG. 2, the apparatus comprises a radix-4 cascading operation module; the radix-4 cascading operation module comprises: a delay switching unit 10, a butterfly operation unit 20, and an output switching unit 30, a twiddle factor generating unit 40 and a complex multiplier 50; the complex multiplier 50 connects to the twiddle factor generating unit 40 and the delay switching unit 10 respectively, the delay switching unit 10 connects to the butterfly operation unit 20, the complex multiplier 50 and the output switching unit 30 respectively, the output switching unit 30 connects to the butterfly operation unit 20 and the delay switching unit 10;

the twiddle factor generating unit 40 is applied to generating a plurality of twiddle factors required by the radix-4 cascading operation module;

the complex multiplier 50 is applied to calculating a product of a serial input data and a corresponding twiddle factor, before transmitting an output data calculated to the delay switching unit 10;

the delay switching unit 10 is applied to delaying the output data calculated by the complex multiplier 50 and a feedback data output by the output switching unit 30 for a preset time and adjusting an order of the output data, before transmitting to the butterfly operation unit 20 and the output switching unit 30 respectively;

the butterfly operation unit 20 is applied to performing a butterfly operation on the output data from the delay switching unit 10, and transmitting a plurality of calculation results to the output switching unit 30;

the output switching unit 30 selects a data from the calculation results of the butterfly operation unit 20 and the data transmitted by the delay switching unit 10, before outputting and feeding back to the delay switching unit 10.

The present embodiment, wherein the twiddle factor generating unit 40 is mainly a read-only memory (ROM), which stores a plurality of twiddle factors W_{N}ⁱ required by the radix-4 cascading operation module, the twiddle factors and the serial input data in the radix-4 cascading operation module are together input into the complex multiplier 50 for a multiplication. The complex multiplier 50 is responsible for calculating a product of the serial input data and a corresponding twiddle factor, before sending a calculated result to the delay switching unit 10, wherein the serial input data InData is a complex number, having a real part (In_DataI) and an imaginary part (In_DataQ). It should be understood that the twiddle factor generating unit 40 may also be calculated by a hardware circuit, which is not limited in the present application.

More specifically, the delay switching unit 10 is a switching circuit having three input and three output, wherein three input channels correspond to a serial input data channel (InData) of the radix-4 cascading operation module and two delayed feedback data ports (FB+ and FB−) of the output switching unit 30 respectively. The delay switching unit 10 makes a data from three input ports be correctly switched to three data output ports through a delay switching state controller 17; a data from an A1 output port and an A2 output port of the delay switching unit 10 will be sent to two input ports of the butterfly operation unit 20, and a data from an A3 output port of the delay switching unit 10 will be sent to the output switching unit 30; two data input ports of the butterfly operation unit 20 are both from the delay switching unit 10, a result after a butterfly operation is sent to B1 and B2 ports of the output switching unit 30. The output switching unit 30 is also a switching circuit having three input and three output, applied to distributing the data of 3 ports input from the delay switching unit 10 and the butterfly operation unit 20 to 3 output ports reasonably through an output switching state controller 34, a first output port of the output switching unit 30 corresponds to a serial output data channel (OutData) of the radix-4 cascading operation module, and 2 other output data ports (FB+ and FB−) of the output switching unit 30 are corresponding to a double-delay-feedback-path of the radix-4 cascading operation module, a data from the two ports will be fed back to two input ports of the delay switching unit 10.

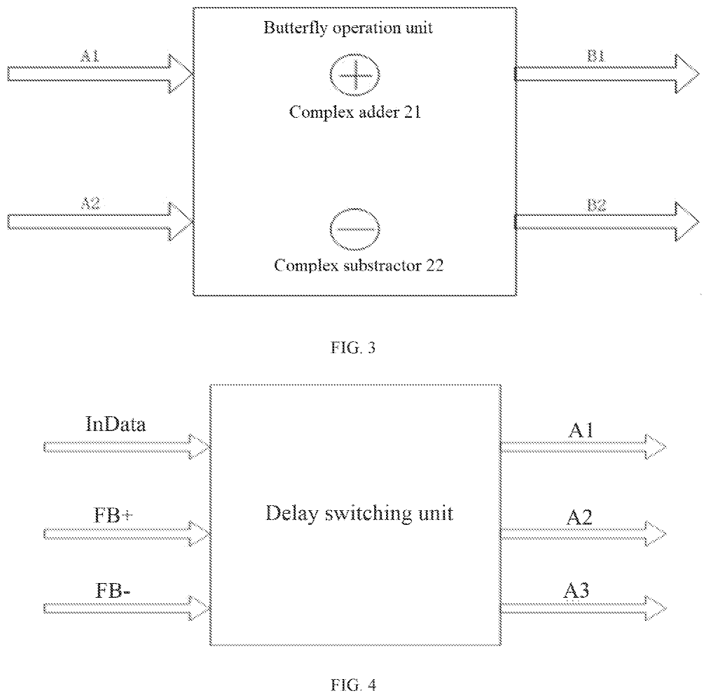

Further, referring to FIG. 3, the butterfly operation unit 20 comprises a complex adder 21 and a complex subtractor 22; the complex adder 21 is applied to performing a time-sharing addition operation on the input data respectively; the complex subtractor 22 is applied to performing a time-sharing subtraction on the input data respectively; the complex adder 21 connects to the delay switching unit 10 and the output switching unit 30; the complex subtractor 22 connects to the delay switching unit 10 and the output switching unit 30.

The present embodiment, wherein the complex adder 21 and the complex subtractor 22 adopt a time-sharing operation mode for an improved usage efficiency, sometimes a running input is an output from the complex multiplier 50 (to calculate A−W_{N}^{2k}C, W_{N}^{k}B−W_{N}^{3k}D, A−W_{N}^{2k}C, W_{N}^{k}B−W_{N}^{3k}D), sometimes the running input is a feedback from the complex adder 21 and the complex subtractor 22 (to calculate E+G, F+J, E−G, F−J), the delay switching unit 10 is responsible for a delay switching scheduling of an input data from the complex adder 21 and from the complex subtractor 22, an output data from the complex multiplier 50 (that is, the serial input data times the twiddle factor) and a feedback data from the complex adder 21/the complex subtractor 22, through a switching scheduling on a data channel and a time sequence by the delay switching unit 10, output 2 complex data flow and send to the complex adder 21/the complex subtractor 22 respectively, to ensure a high-speed and effective time-sharing calculation of the complex adder 21/the complex subtractor 22; due to the time-sharing operation mode of the complex adder 21/the complex subtractor 22, an output result thereof sometimes shall be fed back to the delay switching unit for a next round calculation (E, F, G, H), sometimes may be output directly as an output serial sequence (E+G, F+J) of a current level of the radix-4 cascading operation module, sometimes shall be fed back to the delay switching unit 10 before acting as an output serial sequence (E−G, F−J) of the current level of the radix-4 cascading operation module, due to a single path data connection between the radix-4 cascading operation modules.

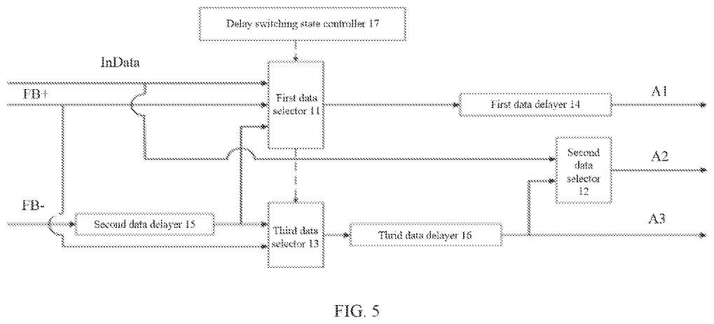

Referencing to FIG. 4 and FIG. 5, the delay switching unit 10 is a small switching circuit with three input and three output, each data input/output port corresponds to a complex data input/output, that is, each input/output comprises a real part (I branch) and an imaginary part (Q branch) of the data, the delay switching unit 10 comprises a first data selector 11, a second data selector 12, a third data selector 13, a first data delayer 14, a second data delayer 15, and a third data delayer 16;

the first data selector 11 connects respectively to the complex multiplier 50, the output switching unit 30, the first data delayer 14 and the second data delayer 15;

the second data selector 12 connects respectively to the complex multiplier 50, the third data delayer 16 and the butterfly operation unit 20;

the third data selector 13 connects respectively to the second data delayer 15, the output switching unit 30 and the third data delayer 16;

the first data delayer 14 connects respectively to the first data selector 11 and the butterfly operation unit 20;

the second data delayer 15 connects respectively to the output switching unit 30, the first data selector 11 and the third data selector 13;

the third data delayer 16 connects respectively to the second data selector 12, the third data selector 13 and the output switching unit 30;

the first data selector 11 is applied to selecting a data from the input data before transmitting to the first data delayer 14;

the second data selector 12 is applied to selecting a corresponding data from the input data before outputting to the butterfly operation unit 20;

the third data selector 13 is applied to s selecting a corresponding data from the input data before transmitting to the third data delayer 16;

the first data delayer 14 is applied to delaying the input data for a first valid clock period before transmitting to the butterfly operation unit 20;

the second data delayer 15 is applied to delaying the input data for a second valid clock period before transmitting to the first data selector 11 and the third data selector 13;

the third data delayer 16 is applied to delaying the input data for a third valid clock period before transmitting to the second data selector 12 and the output switching unit 30.

Wherein, the first data delayer is able to delay the input data for M/2 valid clock period before outputting, the second data delayer and the third data delayer are able to delay the input data for M/4 valid clock period before outputting, M=2N×2⁻ⁱ, M is a data circling period of the radix-4 cascading operation module, N is a length of an FFT calculation. The first data selector is a data selector with three input, the second data selector and the third data selector are data selectors with two input. The first data selector is responsible for selecting an appropriate data for the A1 output port of the delay switching unit 10 (connecting to the butterfly operation unit 20 in the radix-4 cascading operation module) from three input data. The three input data of the first data selector come from the three data input ports of InData, FB+ and FB− in the delay switching unit 10, which correspond respectively to the output of the complex multiplier 50 and the output of the butterfly operation unit 20 in the radix-4 cascading operation module (through the output switching unit 30 and two feedback channels). The second data selector is responsible for selecting an appropriate data from the 2 input data for the A2 output port of the delay switching unit 10 (connecting to the butterfly operation unit 20 in the radix-4 cascading operation module). Two input data of the second data selector, wherein one comes from the data input port of InData in the delay switching unit 10 (corresponding to the output of the complex multiplier 50 in the radix-4 cascading operation module), another comes from an output of the third data selector (which further needs to pass the second data delay device). The third data selector is responsible for selecting an appropriate data from the 2 input data for the A3 output port of the delay switching unit 10 (connecting directly to the in_C port of the output switching unit 30 in the radix-4 cascading operation module). The 2 input data of the third data selector 13 correspond respectively to the FB+ data input port of the delay switching unit 10 (that is, the feedback channel corresponding to the output of the complex adder 21) and the FB− data input port (that is, the feedback channel corresponding to the output of the complex subtractor 22).

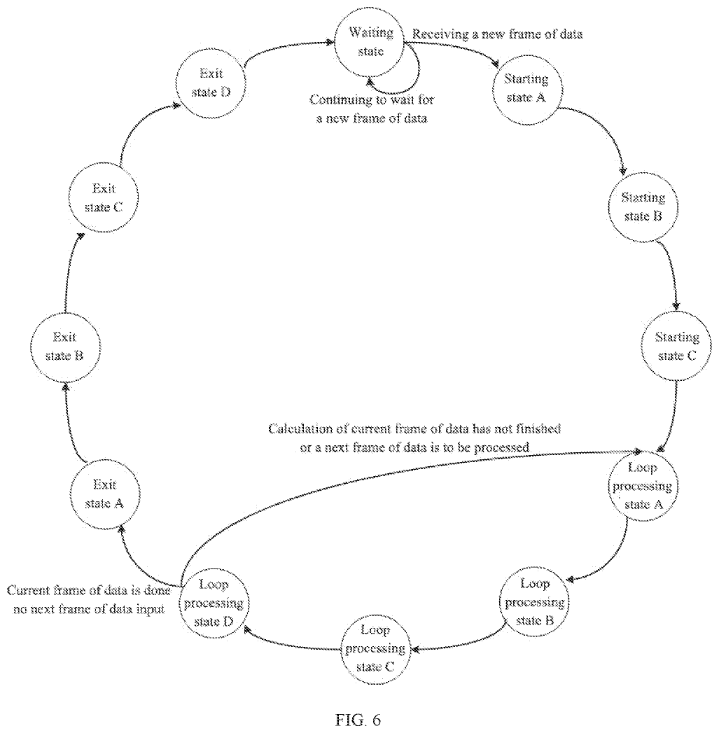

Specifically, a working process of the delay switching unit 10 is further described below, referencing to FIG. 5 and FIG. 6. The delay switching unit 10 is a complex finite state machine circuit, a working state thereof comprises a total of 12 states including a waiting state, a starting state A, a starting state B, a starting state C, a loop processing state A, a loop processing state B, a loop processing state C, a loop processing state D, an exit state A, an exit state B, an exit state C, and an exit state D. In different states, the working states of the three data selectors and the three data delayers in the delay switching unit 10 are defined as follows:

the waiting state (M/2 data cycles): the first data selector, the second data selector, and the third data selector are all closed, without an data output; the second data delayer and the third data delayer 16 have no data; the output ports of A1/A2/A3 have no output; the complex adder 21/the complex subtractor 22 in the radix-4 cascading operation module does not work; the input ports FB+ and FB− connected to the two feedback paths have no data input;

the starting state A (M/2 data cycles): the first data selector selects the data from the port of InData (that is, the output of the complex multiplier 50 in the radix-4 cascading operation module), and the input data enters the data delayer and the first data delayer in a sequence; the second data selector and the third data selector are closed; the second data delayer and the third data delayer have no data; the output ports of A1/A2/A3 have no output; the complex adder 21/the complex subtractor 22 in the radix-4 cascading operation module does not work; the input ports of FB+ and FB− connecting to the two feedback paths have no data input;

the starting state B (M/4 data cycles): the second data selector selects the data from the port of InData (that is, the output of the complex multiplier 50 in the radix-4 cascading operation module), and the input data passes through the second data selector before being output to the A2 port and sent to the add/subtract port of the complex adder 21/the complex subtractor 22 in the radix-4 cascading operation module; at a same time, first M/4 data of the input data from the starting state A entering the first data delayer are output one by one and sent to a summand/subtracted port of the complex adder 21/the complex subtractor 22 in the radix-4 cascading operation module through the A1 port; the complex adder 21/the complex subtractor 22 calculates E/F one by one, for a total of M/4 calculations; a calculation result of the complex adder 21/the complex subtractor 22 is sent to the port of FB+/FB− through two feedback channels, while the first data selector selects a plurality of data from the port of FB+(that is, a feedback channel corresponding to the output of the complex adder 21), the calculation result E of the complex adder 21 enters the first data delayer of the data delayer in turn, and the calculation result F of the complex subtractor 22 enters the second data delayer in turn; while the third data selector is closed at this stage, there is no data output, the third data delayer has no data, and the port of A3 has no data output;

the starting state C (M/4 data cycles): the second data selector selects the data from the port of InData (that is, the output of the complex multiplier 50 in the radix-4 cascading operation module), and the input data passes through the second data selector before being output to the A2 port and sent to the add/subtract port of the complex adder 21/the complex subtractor 22 in the radix-4 cascading operation module; at a same time, last M/4 data of the input data from the starting state A also entering the first data delayer are output one by one and sent to a summand/subtracted port of the complex adder 21/the complex subtractor 22 in the radix-4 cascading operation module through the A1 port; the complex adder 21/the complex subtractor 22 calculates G/H one by one, for a total of M/4 calculations; a calculation result of the complex adder 21/the complex subtractor 22 is sent to the port of FB+/FB− through the output switching unit 30 and two feedback channels, while the third data selector selects the data from the port of FB+(that is, a feedback channel corresponding to the output of the complex adder 21), the calculation result G of the complex adder 21 enters the third data delayer in turn, while the calculation result H of the complex subtractor 22 enters the second data delayer in turn after being transferred into J by the output switching unit 30; at a same time, the first data selector selects and connects to a port connecting with the second data delayer, and the F of the starting state B entered the data delayer is now output from the second data delayer, before entering the first data delayer in turn through the first data selector, and the port of A3 has no data output;

the loop processing state A (M/4 data cycles): the data E of the starting state B or the loop processing state C entering the first data delayer is output to the port of A1 one by one and sent to the summand/subtracted port of the complex adder 21/the complex subtractor 22; the second data selector selects and connects to the port connecting to the second data delayer, and the G of the starting state C or the loop processing state D entering the third data delayer, is now output from the third data delayer, and sent to the add/subtract port of the complex adder 21/the complex subtractor 22 through the second data selector and the output port of A2; the complex adder 21/the complex subtractor 22 calculates (E+G)/(E−G) one by one, for a total of M/4 calculations; the result (E+G) of the complex adder 21 is sent to a radix-4 cascading operation module at a next level by the output switching unit 30 as an output of the radix-4 cascading operation module at a current level, and the result (E−G) of the complex subtractor 22 is sent to the port of FB− of a delay switching unit through a feedback channel, before entering the second data delayer in turn; the data of the input port of FB+ connecting to the feedback channel is not selected and may be discarded directly; at a same time, the data J of the starting state C or the loop processing state D entering the second data delayer is output in turn, now the third data selector selects and connects to the port connecting to the data delayer of Delay (M/4), and J enters the third data delayer in turn; At a same time, an input data of a next cycle is input sequentially from the port of InData, the first data selector selects the data from the port of InData at this time, and an input data of a next cycle starts to enter the first data delayer; and the output data of the port of A3 will be discarded by the output switching unit 30;

the loop processing state B (M/4 data cycles): the data F of the starting state C or the loop processing state D entering the first data delayer is output to the port of A1 one by one and sent to the summand/subtracted port of the complex adder 21/the complex subtractor 22; the second data selector selects and connects to the port connecting to the third data delayer, and the J of the loop processing state A entering the third data delayer is now output from the third data delayer, and sent to the add/subtract port of the complex adder 21/the complex subtractor 22 through the second data selector and the output port of A2; the complex adder 21/the complex subtractor 22 calculates (F+J)/(F−J) one by one, for a total of M/4 calculations; the result (F+J) of the complex adder 21 is sent to the radix-4 cascading operation module at the next level by the output switching unit 30 as the output of the radix-4 cascading operation module at the current level, and the result (F−J) of the complex subtractor 22 is sent to the port of FB− of a delay switching unit through the feedback channel, before entering the second data delayer in turn; the data of the input port of FB+ connecting to the feedback channel is not selected and may be discarded directly; at a same time, the data J of the starting state C or the loop processing state D entering the second data delayer is output in turn, now the third data selector selects and connects to the port connecting to the data delayer of Delay (M/4), and J enters the third data delayer in turn; at a same time, an input data of a next cycle is input sequentially from the port of InData, the first data selector now selects the data from the port of InData, and an input data of a next cycle starts to enter the first data delayer; and an output data of the port of A3 will be discarded by the output switching unit 30;

the loop processing state C (M/4 data cycles): the data of the loop processing state A and the loop processing state B (a next loop) entering the first data delayer is output to the port of A1 one by one and sent to the summand/subtracted port of the complex adder 21/the complex subtractor 22; at a same time, the second data selector selects the data from the port of InData (also a data from the next loop), the input data is output to the A2 port through the second data selector and sent to the add/subtract port of the complex adder 21/the complex subtractor 22 in the radix-4 cascading operation module; the complex adder 21/the complex subtractor 22 calculates an E/F of the next loop one by one, for a total M/4 calculations; a calculation result of the complex adder 21/the complex subtractor 22 is sent to the port of FB+/FB− trough two feedback channels, while the first data selector selects the data from the port of FB+, a calculation result E (of the next loop) of the complex adder 21 enters the first data delayer in turn, while a calculation result F (of the next loop) of the complex subtractor 22 enters the second data delayer 15 in turn; the third data selector selects and connects to a port connecting with the second data delayer, the data (of current loop) of the loop processing state B entering the second data delayer, (F−J) is output in turn, and enters the third data delayer through the third data selector; at a same time, the data (of current loop) of the loop processing state B entering the third data delayer, (E−G) is output in turn, and sent to an port of In_C of the output switching unit 30 through a port of A3, while being sent to the radix-4 cascading operation module at the next level as the output of the radix-4 cascading operation module at the current level by the output switching unit 30;

the loop processing state D (M/4 data cycles): the data of the loop processing state A and the loop processing state B (a next loop) entering the first data delayer of the data delayers is output to the port of A1 one by one and sent to the summand/subtracted port of the complex adder 21/the complex subtractor 22; at a same time, the second data selector selects the data from the port of InData (also a data from the next loop), the input data is output to the A2 port through the second data selector and sent to the add/subtract port of the complex adder 21/the complex subtractor 22 in the radix-4 cascading operation module; the complex adder 21/the complex subtractor 22 calculates a G/H of the next loop one by one, for a total M/4 calculations; a calculation result of the complex adder 21/the complex subtractor 22 is sent to the port of FB+/FB− trough two feedback channels, at a same time, the third data selector selects the data from the port of FB+(that is a feedback channel corresponding to an output of the complex adder 21), a calculation result G (of the next loop) of the complex adder 21 enters the third data delayer in turn, while a calculation result F (of the next loop) of the complex subtractor 22 is converted into J by the output switching unit 30 before entering the second data delayer in turn; at a same time, the first data selector selects and connects to a port connecting to the second data delayer, the F (of the next loop) of the loop processing state C entering the second data delayer is now output from the second data delayer, and enters the first data delayer through the first data selector in turn; at a same time, the data (of current loop) of the loop processing state C entering the third data delayer, (F−J) is output in turn, and sent to an port of In_C of the output switching unit 30 through a port of A3, while being sent to the radix-4 cascading operation module at the next level as the output of the radix-4 cascading operation module at the current level by the output switching unit 30;

the exit state A (M/4 data cycles): the data E of the loop processing state C entering the first data delayer of the data delayers is output to the port of A1 one by one and sent to the summand/subtracted port of the complex adder 21/the complex subtractor 22; the second data selector selects and connects to a port connecting to the third data delayer, and the G of the loop processing state D entering the third data delayer is now output from the third data delayer, and sent to the add/subtract port of the complex adder 21/the complex subtractor 22 through the second data selector and the output port of A2; the complex adder 21/the complex subtractor 22 calculates (E+G)/(E−G) one by one, for a total M/4 calculations; a result (E+G) of the complex adder 21 is sent by the output switching unit 30 as the output of the radix-4 cascading operation module at the current level to the radix-4 cascading operation module at the next level, and the result of the complex subtractor 22 (E−G) is sent to the port of FB− of the delay switching unit through the feedback channel, before entering the second data delayer in turn; the data of the input port FB+ connecting to the feedback channel is not selected and can be discarded directly; at a same time, the data J of the loop processing state D entering the second data delayer is output in turn, now the third data selector selects and connects to the port connecting to the second data delayer, and the J enters the third data delayer in turn; at a same time, the first data selector is closed and there is no input data entering the first data delayer; the output data of the port of A3 will be discarded by the output switching unit 30.

the exit state B (M/4 data cycles): the data E of the loop processing state C entering the first data delayer of the data delayers is output to the port of A1 one by one and sent to the summand/subtracted port of the complex adder 21/the complex subtractor 22; the second data selector selects and connects to a port connecting to the third data delayer, and the G of the loop processing state D entering the third data delayer is now output from the third data delayer, and sent to the add/subtract port of the complex adder 21/the complex subtractor 22 through the second data selector and the output port of A2; the complex adder 21/the complex subtractor 22 calculates (E+G)/(E−G) one by one, for a total M/4 calculations; a result (E+G) of the complex adder 21 is sent by the output switching unit 30 as the output of the radix-4 cascading operation module at the current level to the radix-4 cascading operation module at the next level, and the result of the complex subtractor 22 (E−G) is sent to the port of FB− of the delay switching unit through the feedback channel, before entering the second data delayer in turn; the data of the input port FB+ connecting to the feedback channel is not selected and can be discarded directly; at a same time, the data J of the loop processing state D entering the second data delayer is output in turn, now the third data selector selects and connects to the port connecting to the second data delayer, and the J enters the third data delayer in turn; at a same time, the first data selector is closed and there is no input data entering the first data delayer; the output data of the port of A3 will be discarded by the output switching unit 30;

the exit state C (M/4 data cycles): the first data delayer has no data output; the second data selector is closed; the complex adder 21/the complex subtractor 22 stops working; the first data selector is closed; the third data selector selects and connected to the port connecting to the second data delayer, the data (F−J) of the exit state B entering the second data delayer is output one by one, before entering the third data delayer through the third data selector; at a same time, the data (E−G) of the exit state B entering the third data delayer is output in sequence, and sent to the port of In_C of the output switching unit 30 through the port of A3, before being sent to the radix-4 cascading operation module at the next level by the output switching unit 30 as the output of the radix-4 cascading operation module at the current level.

the exit state D (M/4 data cycles): the first data delayer has no data output; the second data selector is closed; the complex adder 21/the complex subtractor 22 stops working; the third data selector is closed; the first data selector is closed; the data (F−J) of the exit state C entering the third data delayer Delay (M/4) is output one by one, and sent to the port of In_C of the output switching unit 30 through the port of A3, before being sent to the radix-4 cascading operation module at the next level by the output switching unit 30 as the output of the radix-4 cascading operation module at the current level.

It should be noted that, controlling a working state jump of the delay switching unit 10 is in a charge of the delay switching state controller 17, wherein the delay switching state controller 17 controls the first data selector 11, the second data selector 12 and the third data selector 13 select an input data corresponding to a different time respectively, according to a preset switching control instruction. Specifically, a jump between 12 states is shown in FIG. 6: before there is any FFT calculation data input (including an intermediate calculation result), the delay switching unit 10 stays in a waiting state, when receiving a new frame of data, the delay switching unit 10 jumps to a starting state A from the waiting state, then jumps to the starting state B and the starting state C in turn, the starting states complete filling all the data delayers inside the delay switching unit 10; then jumps to the loop processing state A, the loop processing state B, the loop processing state C, the loop processing state D in turn, being able to process M data in one loop, each time when finishing all four states in a loop; each time when the loop processing state D is about to end, the delay switching state controller 17 will detect whether a current frame data has not been calculated yet or there is still a next frame of data to be processed, if so, the delay switching state controller 17 will jump to the loop processing state A to continue working; otherwise, the delay switching state controller 17 will jump to the exit state A, and go over the exit state B and the exit state C in turn, before completing the data processing of a last cycle of the current frame, before finally jumping back to the waiting state, and waiting for an input of a calculation data of a next frame. Since a data number processed by each of 11 work states is fixed, including the starting state A, the starting state B, the starting state C, the loop processing state A, the loop processing state B, the loop processing state C, the loop processing state D, the exit state A, the exit state B, the exit state C, the exit state D, and more, thus the delay switching state controller 17 may be achieved by a counter and a simple logic judgment circuit.

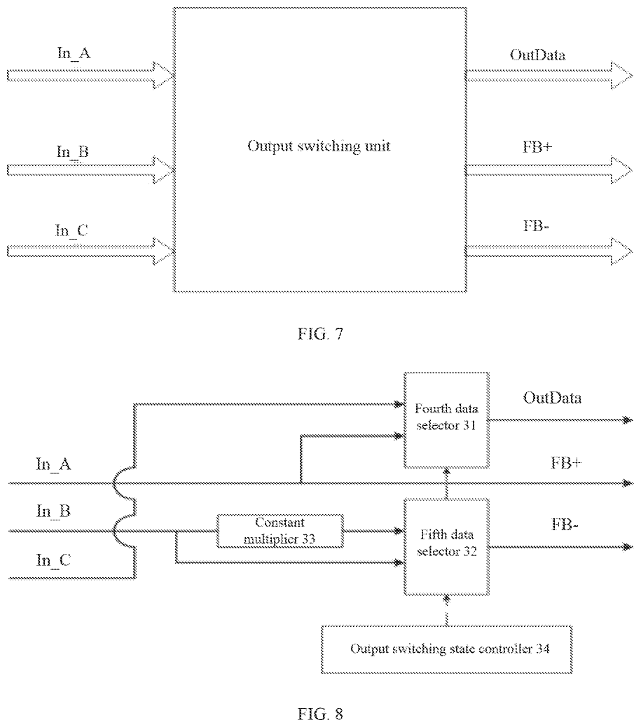

Referencing to FIG. 7 and FIG. 8, the output switching unit 30 is a small switching circuit with three input and three output, each data input/output port is corresponding to a complex data input/output, that is, each input/output comprises a real part (I branch) and an imagery part (Q branch) of the data, the output switching unit 30 comprises a fourth data selector 31, a fifth data selector 32, and a constant multiplier 33;

the fourth data selector 31 connects respectively to the butterfly operation unit 20 and the delay switching unit 10;

the fifth data selector 32 connects respectively to the butterfly operation unit 20, the constant multiplier 33 and the delay switching unit 10;

the constant multiplier 33 connects respectively to the butterfly operation unit 20 and the fifth data selector 32;

the fourth data selector 31 is applied to selecting a data from the output data of the butterfly operation unit 20 or the delay switching unit 10 as a calculation result for output;

the fifth data selector 32 is applied to selecting a data from the output data of the butterfly operation unit 20 or the constant multiplier 33 before feeding back to the delay switching unit 10;

the constant multiplier 33 is applied to performing a rotation and complement operation on a real part and an imaginary part of the input data, before transmitting an operation result to the fifth data selector 32.

The present embodiment, wherein the output switching unit 30 has together three input ports of In_A/In_B/In_C and three output ports of Out_Data/FB+/FB−; the input ports of In_A/In_B connect to the output ends of the complex adder 21/the complex subtractor 22 of the radix-4 cascading operation module, the port of In_C connects to the output port of A3 of the delay switching unit 10; an output port of Out_Data acts as a data output port of the radix-4 cascading operation module directly, the output ports of FB+/FB− interconnects to the input ports FB+/FB− of the delay switching unit 10 through two feedback paths.

Further, a whole switching unit is composed by the fourth data selector/the fifth data selector and a constant multiplier (−j); both the fourth data selector and the fifth data selector are data selectors with two inputs, the fourth data selector

selects an appropriate data from the port of In_A or the port of In_C before sending to the output port of OutData, and the fifth data selector selects an appropriate data from the port of In_B or an output port of the constant multiplier (−j), before sending to the output port of FB−; the constant multiplier (−j) is responsible for converting a data H input from an end of In_B into J(J=H×(−j)). The constant multiplier (−j) does not require any hardware multiplier, but a rotation and complementation to the real part (I branch) and the imaginary part (Q branch) of the complex data input.

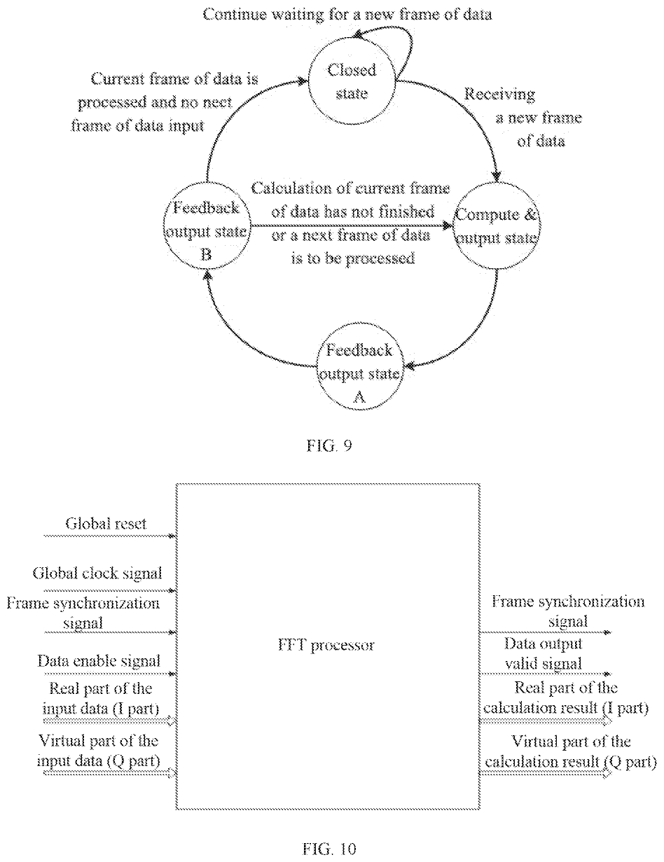

Specifically, a further description on a working process of the output switching unit 30 is stated hereafter, referencing to FIG. 8 and FIG. 9. The output switching unit 30 is a finite state machine circuit, a working state thereof comprises 4 states of a closed state, a compute and output state, a feedback and output state A, a feedback and output state B. In different states, the working states of the two data selectors and the constant multiplier in the output switching unit 30 are defined as follows:

the closed state: in a current state, the fourth data selector and the fifth data selector are closed, the port of OutData has no output data, the port of FB− has no output data, and the data output from the port of FB+ will be discarded by the delay switching unit 10 automatically;

the compute and output state: the present state corresponds to a time point when the adder/subtractor in the radix-4 cascading operation module is calculating (E+G)/(E−G) and (F+J)/(F−J) (total M/2 calculations), The fourth data selector selects the data of (E+G) and (F+J) of the port of In_A, and outputs the data of (E+G) and (F+J) through the port of OutData as the output of the radix-4 cascading operation module of the current level to the radix-4 cascading operation module of the next level; at a same time, the fifth data selector selects the data of (E−G) and (F−J) from the port of In_B, before sending the data of (E−G) and (F−J) through the port of FB− and the feedback paths to the input port of FB− of the delay switching unit 10, then the data of (E−G) and (F−J) will be buffered in the delay switching unit 10 and waiting for an output; at this time, the data of (E+G) and (F+J) of the port of In_A will also be sent to the input port of FB+ of the delay switching unit 10 through the port of FB+ and the feedback paths, however the delay switching unit 10 will discard this part of data automatically.

The feedback and output state A: the present state is calculated M/4 times as a total. The fourth data selector selects and connects to the port of In_C, the data (E−G) previously buffered in the delay switching unit 10 (from a previous cycle) is output through the port of OutData as an output of the radix-4 cascading operation module at the present level to the radix-4 cascading operation module at the next level; at a same time, the fifth data selector selects the data F from the port of In_B, before sending the data F to the input port of FB− in the delay switching unit 10 through the port of FB− and the feedback path, the data F will be buffered in the delay switching unit 10 for a next calculation; while the data E of the port of In_A will also be sent to the input port of FB+ in the delay switching unit 10 through the port of FB+ and the feedback path. The data E will be buffered in the delay switching unit 10 and waiting for a next calculation.

The feedback and output state B: the present state is calculated M/4 times as a total. The fourth data selector selects and connects to the port of In_C, the data (F−J) previously buffered in the delay switching unit 10 (from a previous cycle) is output through the port of OutData as an output of the radix-4 cascading operation module at the present level to the radix-4 cascading operation module at the next level; at a same time, a calculation result H of the subtractor of the radix-4 cascading operation module is sent to the input port of In_B, the constant multiplier (−j) converts the H into J (J=H×(−j)) before outputting, the fifth data selector selects the data F from the port of In_B, before sending the data F to the input port of FB− in the delay switching unit 10 through the port of FB− and the feedback path, the data F will be buffered in the delay switching unit 10 for a next calculation; while the data G of the port of In_A will also be sent to the input port of FB+ in the delay switching unit 10 through the port of FB+ and the feedback path. The data G will be buffered in the delay switching unit 10 and waiting for a next calculation.

It should be noted that, controlling a working state jump of the output switching unit 30 is in a charge of the output switching state controller 34, wherein the output switching state controller 34 controls the fourth data selector 31 and the fifth data selector 32 select an input data corresponding to a different time respectively, according to a preset switching control instruction. Specifically, a jump between 4 states is shown in FIG. 9: when the complex adder 21/the complex subtractor 22 of the radix-4 cascading operation module has no data input to the output switching unit 30, the output switching unit 30 stays in a closed state; when receiving a new frame of data, the output switching unit 30 jumps to a compute and output state from the closed state, then jumps to a feedback output state A and a feedback output state B in turn, being able to output M data in one loop, each time when finishing the compute and output state/the feedback output state A/the feedback output state B in a loop; each time when the feedback output state B is about to end, the output switching state controller 34 will detect whether a current frame data has not been output yet or there is still a next frame of data to be processed, if so, the output switching state controller 34 will jump to the compute and output state to continue working; otherwise, the output switching state controller 34 will jump to the closed state, waiting for a next frame of data input. Since each time a data number processed by the 3 work states is fixed, including the compute and output state, the feedback output state A, the feedback output state B and more, thus the output switching state controller 34 may be achieved by a counter and a simple logic judgment circuit.

Based on the feedback apparatus stated above, the present application further provides an FFT/IFFT processor, shown as FIG. 10 (the figure shows only an FFT processor), wherein comprising the feedback apparatus stated above.

The present embodiment, wherein an external port of the FFT/IFFT processor comprises an input port and an output port, wherein the input port comprises: reset, clock, In_DataSync, In_DataEna, In_DataI and In_DataQ, wherein the reset and the clock are a global reset and a global clock signal; the In_DataI and the In_DataQ are serial input data, that is, an input data of N time periods attending an N-point FFT calculation, the In_DataI is a real part of the input data (I part) and the In_DataQ is a virtual part of the input data (Q part); the In_DataEna is a data enable signal, and only when the In_DataEna is valid, will the In_DataI and the In_DataQ input are valid; the In_DataSync is a frame synchronization signal, for a data frame composed by the FFT data in a number N, the In_DataSync is valid only when a first data of a data frame is input, and the In_DataSync is invalid at other time.

The output port of the FFT processor comprises Out_DataSync, Out_DataValid, Out_DataI and Out_DataQ, wherein the Out_DataI and the Out_DataQ are serial output data, that is, an output result in a frequency field of the N-point FFT calculation, the output result is also a data of N, the Out_DataI is a real part (I part) of the calculation result and the Out_DataQ is a virtual part (Q part) of the calculation result; the Out_DataValid is a data output valid signal, and only when the Out_DataValid is valid, will the Out_DataI and the Out_DataQ in an output result are valid, the FFT processor adopts a method of outputting a result continuously in serial, during a process of the FFT processor outputting the calculation result of a frame, the Out_DataSync is continuous and valid; the Out_DataSync is a frame synchronization signal, when a data frame composed by an N-point FFT calculation result is output, the Out_DataSync is valid only when outputting a first data of the data frame, and the Out_DataSync outputs an invalid level at all other time.

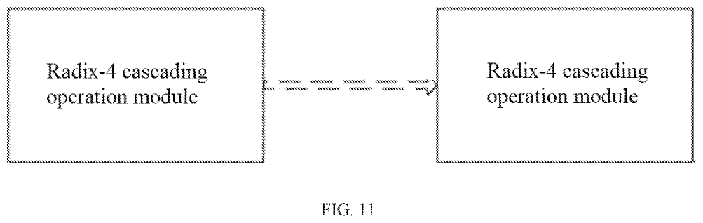

Referencing to FIG. 11, the FFT calculation is decomposed into L-level of radix-4 decomposition operations, each radix-4 cascading operation module is responsible for a radix-4 decomposition operation of one level thereof, and all together there are a number of L radix-4 cascading operation modules. And the radix-4 operation module adopts a R4SP-DDF Implementation structure, that is, adopting a single-path data transfer mode between the radix-4 operation modules (that is, a single data serial transmission method is adopted). The FFT/IFFT processor related to the present application has a total number of L radix-4 cascading operation modules, a calculation method of L is as follows:

L=┌log₄ N┐, wherein, decomposing an FFT calculation into L levels of radix-4 decomposition operation, each radix-4 cascading operation module is responsible for one level of the radix-4 decomposition operation thereof, there are radix-4 cascading operation modules in a number of L, and N is a length of the FFT calculation, ┌⋅┐ is a round-up function.

Further, for an i-th radix-4 cascading operation module, a data cycle period M is calculated as follows: M=4N*4⁻ⁱ, wherein M is the data cycle period of a certain radix-4 cascading operation module, N is a length of the FFT calculation, i∈[1, L];

It is noted that, the N-point FFT calculation requires an L-level cascading radix-4 decomposition operation. Specifically, for each radix-4 decomposition operation, an input data A/B/C/D is not a continuous input, and an amount of interval data depends on a level of a current radix-4 decomposition locating at the decomposition operation with L levels. Let 4 times of an interval data between the A/B/C/D be M, that is, between data A and B, between B and C, and between C and D, there is an interval of M/4 data. For an i-th radix-4 cascading operation module, although a length of the data of one frame of FFT operation is 4^{L}, a data length of one operation processing cycle is M, and M can be calculated by the following formula:

M=4N*4⁻ⁱ, wherein M is the data cycle period of a certain radix-4 cascading operation module, N is a length of the FFT calculation, i∈[1, L].

All above, the present application provides a feedback apparatus and an FFT/IFFT processor, the apparatus comprises a radix-4 cascading operation module; the radix-4 cascading operation module comprises: a twiddle factor generating unit, a complex multiplier, a delay switching unit, a butterfly operation unit, and an output switching unit; the complex multiplier connects to the twiddle factor generating unit and the delay switching unit respectively, the delay switching unit connects to the butterfly operation unit, the complex multiplier and the output switching unit respectively, the output switching unit connects to the butterfly operation unit and the delay switching unit. On a basis of making a full use of the complex multiplier, the present invention improves effectively a use efficiency of the complex adder/subtractor by using a double-delay feedback structure circuit and designing a data delay buffer channel ingeniously, reducing a number of the complex adders required significantly, and improving a circuit efficiency significantly; which has solved effectively a problem of the R4SDF structure and the R4SDC structure occupying more complex adders/subtractors.

It should be understood that, the application of the present application is not limited to the above examples listed. Ordinary technical personnel in this field can improve or change the applications according to the above descriptions, all of these improvements and transforms should belong to the scope of protection in the appended claims of the present application.

1. A feedback apparatus, wherein the apparatus comprises a radix-4 cascading operation module; the radix-4 cascading operation module comprises: a twiddle factor generating unit, a complex multiplier, a delay switching unit, a butterfly operation unit, and an output switching unit; the complex multiplier connects to the twiddle factor generating unit and the delay switching unit respectively, the delay switching unit connects to the butterfly operation unit, the complex multiplier and the output switching unit respectively, the output switching unit connects to the butterfly operation unit and the delay switching unit;
the twiddle factor generating unit is applied to generating a plurality of twiddle factors required by the radix-4 cascading operation module;
the complex multiplier is applied to calculating a product of a serial input data and a corresponding twiddle factor, before transmitting an output data calculated to the delay switching unit;
the delay switching unit is applied to delaying the output data calculated by the complex multiplier and a feedback data output by the output switching unit for a preset time and adjusting an order of the output data, before transmitting to the butterfly operation unit and the output switching unit respectively;
the butterfly operation unit is applied to performing a butterfly operation on the output data from the delay switching unit, and transmitting a plurality of calculation results to the output switching unit;
the output switching unit selects a data from the calculation results of the butterfly operation unit and the data transmitted by the delay switching unit, before outputting and feeding back to the delay switching unit.

2. The feedback apparatus according to claim 1, wherein the feedback apparatus, wherein the delay switching unit comprises a first data selector, a second data selector, a third data selector, a first data delayer, a second data delayer, and a third data delayer;
the first data selector connects respectively to the complex multiplier, the output switching unit, the first data delayer and the second data delayer;
the second data selector connects respectively to the complex multiplier, the third data delayer and the butterfly operation unit;
the third data selector connects respectively to the second data delayer, the output switching unit and the third data delayer;
the first data delayer connects respectively to the first data selector and the butterfly operation unit;
the second data delayer connects respectively to the output switching unit, the first data selector and the third data selector;
the third data delayer connects respectively to the second data selector, the third data selector and the output switching unit;
the first data selector is applied to selecting a data from the output data of the complex multiplier, the output switching unit or the second data delayer, before transmitting to the first data delayer;
the second data selector is applied to selecting a data from the output data of the complex multiplier or the third data delayer, before outputting to the butterfly operation unit;
the third data selector is applied to selecting a data from the output data of the second data delayer or the output switching unit, before transmitting to the third data delayer;
the first data delayer is applied to delaying the data selected by the first data selector for a first valid clock period before transmitting to the butterfly operation unit;
the second data delayer is applied to delaying the output data from the output switching unit for a second valid clock period before transmitting to the first data selector and the third data selector;
the third data delayer is applied to delaying the data selected by the third data selector for a third valid clock period before transmitting to the second data selector and the output switching unit.

3. The feedback apparatus according to claim 2, wherein the feedback apparatus, wherein the delay switching unit further comprises a delay switching state controller;
the delay switching state controller is applied to controlling the first data selector, the second data selector, and the third data selector to select an input data correspondingly at a different time point according to a preset switching control instruction.

4. The feedback apparatus according to claim 1, wherein the feedback apparatus, wherein the butterfly operation unit comprises a complex adder and a complex subtractor;
the complex adder is applied to performing a time-sharing addition operation on the input data respectively before transmitting to the output switching unit;
the complex subtractor is applied to performing a time-sharing subtraction on the input data respectively before transmitting to the output switching unit;
the complex adder connects to the delay switching unit and the output switching unit;
the complex subtractor connects to the delay switching unit and the output switching unit.

5. The feedback apparatus according to claim 1, wherein the feedback apparatus, wherein the output switching unit comprises a fourth data selector, a fifth data selector, and a constant multiplier;
the fourth data selector connects respectively to the butterfly operation unit and the delay switching unit;
the fifth data selector connects respectively to the butterfly operation unit, the constant multiplier and the delay switching unit;
the constant multiplier connects respectively to the butterfly operation unit and the fifth data selector;
the fourth data selector is applied to selecting a data from the output data of the butterfly operation unit or the delay switching unit as a calculation result for output;
the fifth data selector is applied to selecting a data from the output data of the butterfly operation unit or the constant multiplier before feeding back to the delay switching unit;
the constant multiplier is applied to performing a rotation and complement operation on a real part and an imaginary part of the input data, before transmitting an operation result to the fifth data selector.

6. The feedback apparatus according to claim 5, wherein the feedback apparatus, wherein the output switching unit further comprises an output switching state controller;
the output switching state controller is applied to controlling the fourth data selector and the fifth data selector to select an input data at a different time point correspondingly according to a preset switching control instruction.

7. An FFT/IFFT processor, wherein comprising a plurality of radix-4 cascading operation modules in a number of L in the feedback apparatus according to claim 1;
a calculation method of the radix-4 cascading operation modules in the number of L is as follows:
L=┌log₄ N┐, wherein decomposing an FFT calculation into L levels of radix-4 decomposition operation, each radix-4 cascading operation module is responsible for one level of the radix-4 decomposition operation thereof, there are radix-4 cascading operation modules in a number of L, and N is a length of the FFT calculation, ┌⋅┐ is a round-up function.

8. The FFT/IFFT processor according to claim 7, wherein the FFT/IFFT processor, wherein for an i-th radix-4 cascading operation module, a data cycle period M is calculated as follows:
M=4N*4⁻ⁱ, wherein M is the data cycle period of a certain radix-4 cascading operation module, N is a length of the FFT calculation, i∈[1, L].

9. The FFT/IFFT processor according to claim 7, wherein each radix-4 cascading operation module in the radix-4 cascading operation modules in the number of L adopts a single-path data transmission in between.
